(19) United States
(12) Patent Application Publication
(10) Pub. No.: US 2010/0257329 A1
(43) Pub. Date: Oct. 7, 2010

(54) APPARATUS AND METHOD FOR LOADING AND STORING MULTI-DIMENSIONAL ARRAYS OF DATA IN A PARALLEL PROCESSING UNIT

(76) Inventors: Brucek Khailany, San Francisco, CA (US); Nuwan Jayasena, Sunnyvale, CA (US); Brian Pharris, Sunnyvale, CA (US); Timothy Southgate, Woodside, CA (US)

Correspondence Address: MAHAMEDI PARADICE KREISMAN LLP, 550 Winchester Boulevard, Suite 605, SAN JOSE, CA, 95128, US

(21) Appl. No.: 12/537,195

(22) Filed: Aug. 6, 2009

Related U.S. Application Data
(60) Provisional application No. 61/166,224, filed on Apr. 2, 2009.

(51) Int. Cl. G06F 12/02

(52) U.S. Cl. 711/163; 711/167; 711/154; 711/E12.002

(57) ABSTRACT

An application programming interface is disclosed for loading and storing multidimensional arrays of data between a data parallel processing unit and an external memory. Physical addresses reference the external memory and define two-dimensional arrays of data storage locations corresponding to data records. The data parallel processing unit has multiple processing lanes to parallel process data records residing in respective register files. The interface comprises an X-dimension function call parameter to define an X-dimension in the memory array corresponding to a record for one lane and a Y-dimension function call parameter to define a Y-dimension in the memory array corresponding to the record for one lane. The X-dimension and Y-dimension function call parameters cooperate to generate memory accesses corresponding to the records.

### CROSS-REFERENCE TO RELATED APPLICATIONS

This application claims priority from, and hereby incorporates by reference, U.S. Provisional Application No. 61/166,224, filed Apr. 2, 2009 and entitled “Method for Loading and Storing Multi-Dimensional Arrays of Data in a Data Parallel Processing Unit.”

### TECHNICAL FIELD

The disclosure herein relates to design and operation of parallel processing systems and components thereof. This invention was made with Government support under Contract No. W31P4Q-08-C-0225 awarded by the U.S. Army Aviation and Missile Command. The Government has certain rights in the invention.

### BACKGROUND

Stream processing is an approach to parallel computing that exploits large amounts of available instruction-level and data-level parallelism. By explicitly managing data movement between off-chip and on-chip memory, high memory bandwidth may be achieved while maximizing processing efficiency. Applications that take advantage of stream processing include image processing, signal processing, and scientific computing, to name a few.

One of the difficulties encountered with parallel processors involves organizing the data among the processing units. Programming and executing applications to take advantage of the parallel resources generally involves organizing the data across the multiple resources—a process known as data scattering and gathering. In a data parallel processor, these parallel resources are often referred to as lanes.

While conventional parallel processing approaches address the data scattering and gathering problem somewhat, room for improvement exists. Consequently, the need exists for improvements in parallel software and hardware features. The apparatus and methods described herein satisfy these needs.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an embodiment of a stream processor;

FIG. 2 illustrates an embodiment of a memory subsystem capable of accepting memory-load and memory-store stream commands with various strided and indirect access patterns within the stream processor of FIG. 1;

FIG. 3 illustrates an embodiment of the load interface and store interface to the LRF within a given execution lane;

FIG. 4 illustrates an embodiment of an address generator suitable for use in the memory subsystem of FIG. 2;

FIG. 5 illustrates a 2D strided record access to external memory through use of one embodiment of an application programming interface (API); and

FIG. 6 illustrates a 2D indirect record access to external memory through use of one embodiment of the application programming interface; and

FIG. 7 illustrates the relative pointer positions between 16 lanes as managed within the address generator of FIG. 4.

### DETAILED DESCRIPTION

### System Overall Structure

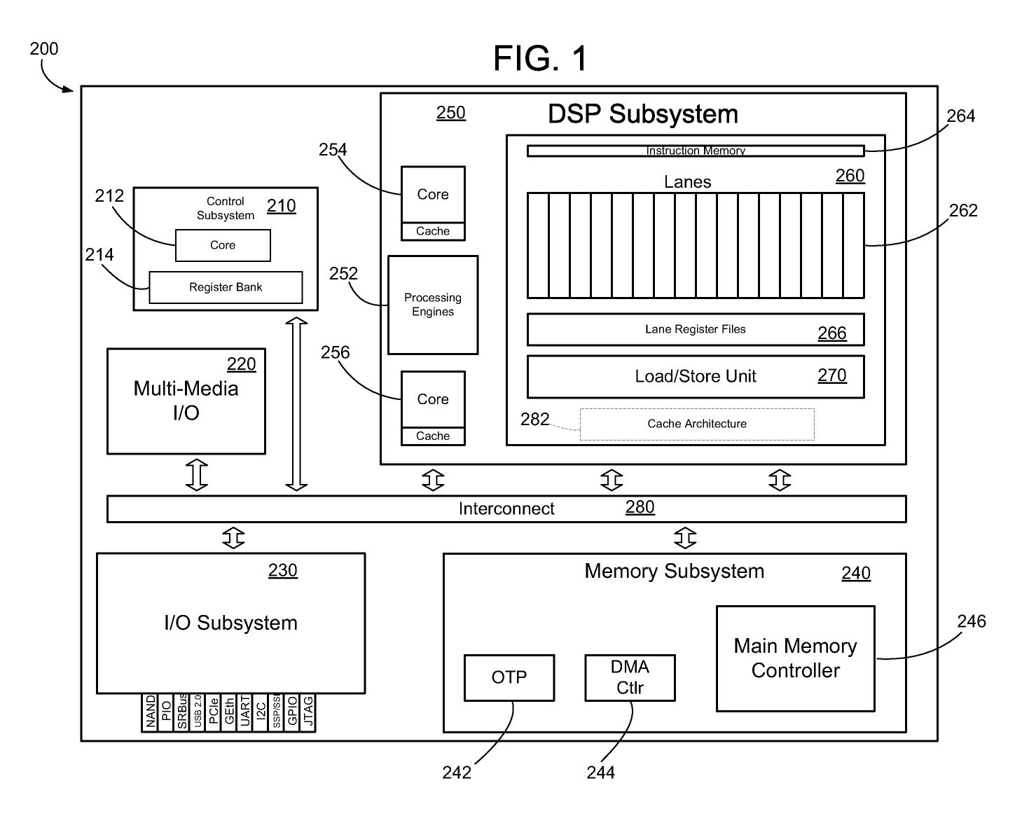

Referring now to FIG. 1, the stream processor 200 in one embodiment takes the form of a system-on-chip (SOC) architecture that includes a control subsystem 210, a variety of I/O subsystems 220 and 230, a memory subsystem 240 and a DSP subsystem 250. Interconnect circuitry 280 ties together all of the various subsystems. While the embodiment discussed below includes specific components and interfaces, it should be understood that in alternative embodiments, any one of the components or interfaces may be eliminated and/or further include additional components to suit the needs of a given application.

Further referring to FIG. 1, the control subsystem 210 in one embodiment incorporates a processor core 212 comprising a general-purpose programmable MIPS CPU core with cache capabilities. A register bank 214 provides programmable storage for status, control, interrupts, semaphores, software timers, and so forth.

The I/O subsystems 220 and 230 provided by the stream processor 200 vary depending on the applications envisioned, but in one embodiment comprise a multi-media I/O unit and a peripheral I/O subsystem. The multi-media I/O includes, for example, video interface circuitry to tie the stream processor to video input/output devices (not shown) or the like. The peripheral I/O subsystem provides a variety of physical interfaces that enable the processor to communicate to various peripherals such as nonvolatile memory, USB, multiple lanes of PCIe, and JTAG, to name but a few.

The memory subsystem 240 employed by the stream processor 200 generally provides on-chip memory control functions in addition to managing external main memory resources. A one-time-programmable (OTP) memory unit 242 provides a form of ROM memory to store set control parameters. To manage on-chip direct memory accesses, a DMA controller 244 is provided. A main memory controller 246 manages transactions between an external main memory (not shown), and the stream processor. In one embodiment, the external main memory comprises DRAM, having storage parameters and protocols depending on the DRAM architecture employed (DDR2, DDRN, GDDRN, XDR, etc.).

With continued reference to FIG. 1, the DSP subsystem 250 in one embodiment employs an optional host CPU 254 to execute main application code. Commands issued by the host CPU to the stream processor, referred to herein as stream commands, instruct the stream processor when to load and store instructions and data to/from an external memory (not shown) into the stream processor's local instruction memory 264 and lane register files 266 and when to execute computation kernels in an execution unit to process this data.

The host CPU 254 may run C code with a programmer specifying stream loads and stores and kernel function calls. In a stream processing system, compiler tools generally convert the stream and kernel calls into explicit commands that move streams of data on and off-chip and execute kernel function calls that process those streams on a co-processor. Features that enhance these functions are more specifically described below.

Further referring to FIG. 1, the DSP subsystem employs a C-programmable data parallel unit 260 based on a SIMD/VLIW (single-instruction-multiple-data/very-long-instruction-word) stream processor architecture with a bandwidth-optimized memory system. In one specific embodiment, the data parallel unit advantageously employs 80 integer arithmetic logic units (ALU's) organized as a 16-wide SIMD 5-ALU VLIW processing array of lanes 262. The specific architecture of the data parallel unit is highly configurable and thus may include more or less lanes, ALU's or other resources depending on the application.

For certain applications, one or more optional application-specific accelerators in the form of processing engines 252 may be employed. Examples of applications that benefit from accelerators include motion estimation, video bitstream encoding/decoding, and cryptography. Besides the host CPU 254 described above, the DSP subsystem 250 may incorporate other general-purpose processing resources in the form of MIPS CPU core 256.

Further referring to FIG. 1, the data parallel unit 260 employs VLIW instruction memory 264 and lane register file (LRF) data memory 266 to support operation of the lanes 262. Generally speaking, the size of the instruction memory and LRF memory should be sufficient to support large data working sets and a higher number of kernels on-chip simultaneously. In one embodiment, 384 KB of VLIW instruction memory may be utilized in concert with 512 KB of LRF data memory.

The data parallel unit 260 also incorporates a unique load/store unit 270 that transfers streams of user-defined records between external memory and the LRF via the interconnect 280. The interconnect facilitates communication between the on-chip stream processor resources. Both the load/store unit and a portion of the interconnect are described more fully below. In an optional configuration, the load/store unit cooperates with a cache architecture 282. Further details of one specific embodiment of the cache architecture are found in copending U.S. patent application Ser. No. 12/537,098, titled “Apparatus and method for a data cache optimized for streaming memory loads and stores”, filed Aug. 6, 2009, assigned to the assignee of the present invention, the entirety of which is expressly incorporated herein by reference.

### Stream Load/Store Unit Structure

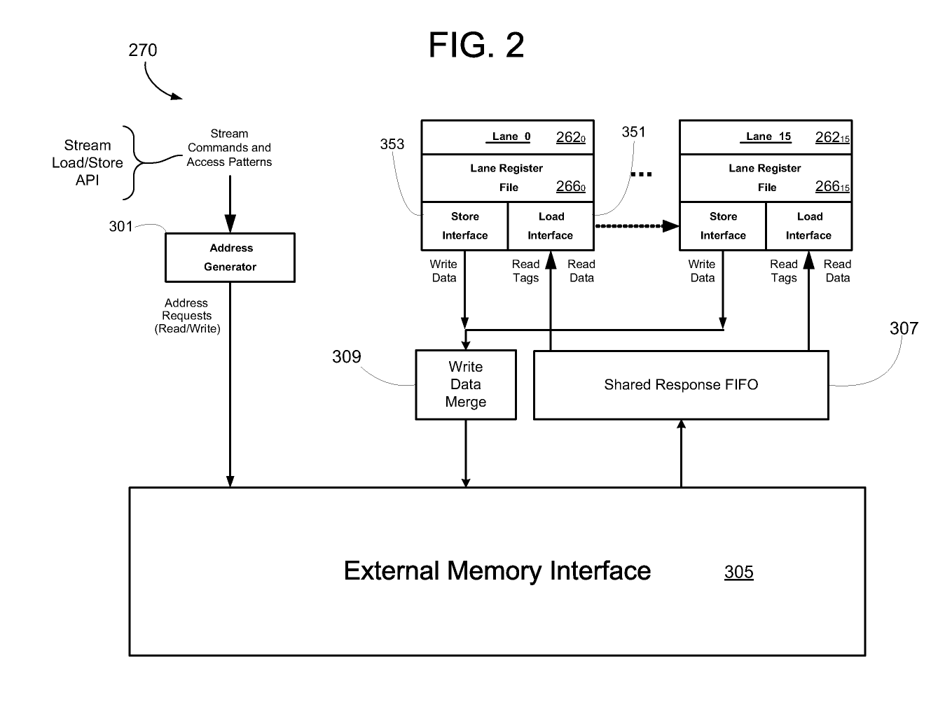

The stream load/store unit 270 handles all aspects of executing loads and stores between the lane register files and external memory. It assembles address sequences into bursts based on flexible memory access patterns, thereby eliminating redundant burst fetches from external memory. It also manages stream partitioning across the lanes 262₀-262₁₅ (FIG. 2).

Referring now to FIG. 2, one embodiment of the load/store unit 270 and interrelated circuitry from FIG. 1, includes a variety of components and interconnections defining respective request and return paths between the external main memory (not shown) and the data parallel unit 260 (FIG. 1) via an external memory interface 305. For consistency, it should be understood that the external memory interface is a compilation of many of the structures shown in FIG. 1, such as the memory subsystem 240, portions of the interconnect 280, portions of the cache architecture 282, etc. As noted above, the data parallel unit employs multiple lanes 262, each having dedicated lane register files 266 (LRF) as a temporary storage for kernel execution. The lane register files form a portion of the load/store circuitry and interact with respective load and store interfaces 351 and 353 (FIG. 2).

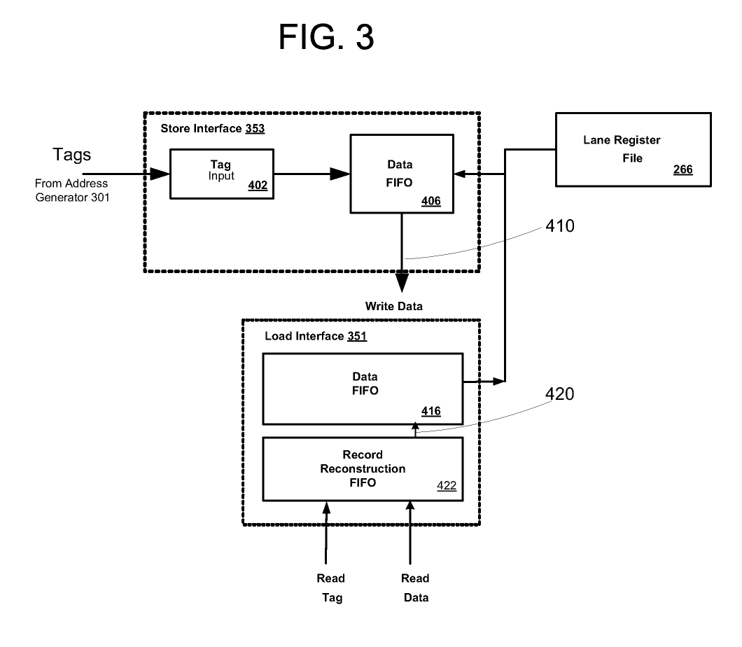

With reference now to FIG. 3, the store interface 353, forms an important part of the request path to enable the transmission of data bursts collected from across multiple lane register files 266 while maximizing request bandwidth. The store interface 353 includes a tag input 402 to receive tags from an address generator 301 (FIG. 2) and forward the tags to a write data FIFO 406. Tags are described in more detail below with respect to the address generator structure. The write data FIFO receives data from the LRF 266 for writing to external memory (“storing”) via write data path 410, which forms a portion of the request path. Note that in general, the request path comprises the resources (address generator 301, store interface 353, associated interconnect routing) to carry out memory write transactions (sending data to external memory for storage). A write data merge unit 309 (FIG. 2) pre-packages the final data bursts before sending out to external memory.

Further referring to FIG. 3, the load interface 351, often referred to as a load response FIFO, includes a record reconstruction FIFO 422 having inputs to receive read tags and read data from a shared response FIFO 307 (FIG. 2). The record reconstruction FIFO decodes the tag information and provides its input to a data FIFO 416. The output from the data FIFO couples to the lane register file 266.

The record reconstruction FIFO 422 plays an important role in the operation of the return path, described more fully below. The return path includes the resources (load interface and associated routing) to complete memory read transactions (returning data from external memory for loading into the LRFs). Generally speaking, however, the reconstruction FIFO reassembles sequences of bursts directed to a particular lane from the external memory domain into records suitable for processing within the lane 266. The return path advantageously supports byte-addressed records in this manner, and packs data into the LRFs so they can be read at very high bandwidth during kernels.

Referring briefly back to FIG. 2, the load/store unit 270 includes a unique address generator 301 to interact with the load/store interfaces 351 and 353 such that the request path is decoupled from the return path. Generally speaking, the address generator manages the flow of data out of the LRFs 266 for efficient transfer to external memory. In this capacity, the address generator forms a key part of the request path.

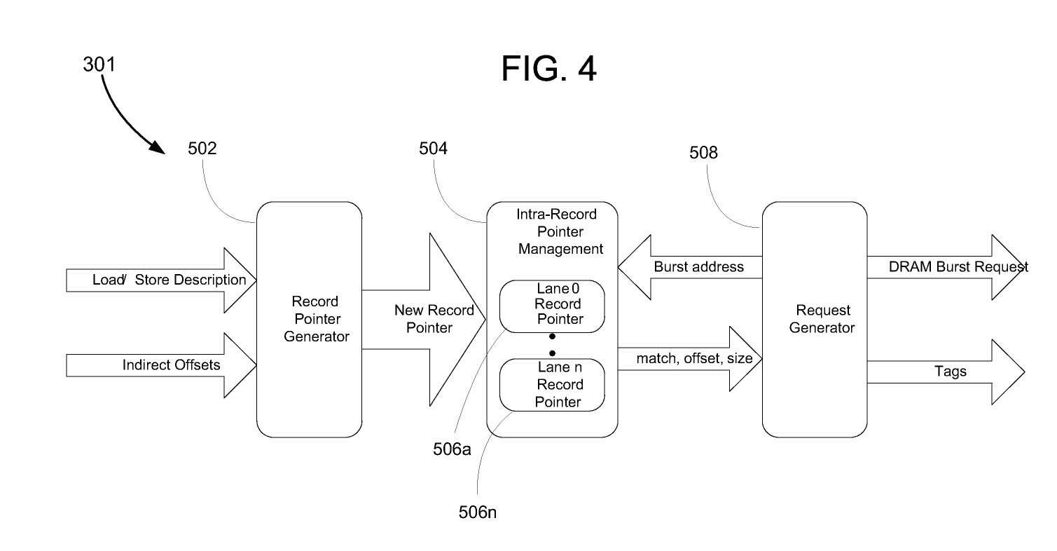

Specifically referring now to FIG. 4, the address generator 301 employs a record pointer generator 502 that receives load/store descriptions in the form of strided or indirect patterns, and indirect offset information, should the received pattern comprise an indirect pattern. More details on the patterns and a corresponding application programming interface (API) are described below with respect to system operation. The record pointer generator couples to an intra-record pointer management module 504 that includes per-lane processing resources 506a-506n to model respective intra record pointers for each lane 262. A request generator 508 receives data parameter information from the intra-record pointer management module and generates memory requests, addresses and tags (including the parameter information).

The tags created by the address generator 301 enable the decoupling of the request path from the return path. This allows for memory latency tolerance without requiring large return data FIFOs. Implementing most of the system “smarts” in the address generator in an asymmetric manner allows the rest of the interconnecting paths (such as the return path) to merely operate according to the tags received. To accomplish this, tags initially get sent out to the external main memory controller 246 (FIG. 1), or alternatively a cache. Tags may include information such as the beginning and end of a record, and also specific lane information relating to bursts. For example, a tag may include the number of bytes in the burst that belongs to a particular lane, the offset of those bytes within a particular record (for record reconstruction), as well as additional control information that indicates whether it's the last chunk in a record. The additional control information may indicate that the reconstruction FIFO 422 (FIG. 3) needs to be padded out (with zeroes), or flushed out (emptied).

### Load/Store Operation—Application Programming Interface

One programming model for a system that includes the stream processor of FIG. 1 consists of a main instruction stream running on the host CPU 254 and separate computation kernels that run on the stream processor 200. The host CPU dispatches stream commands for respective strips of data and loops over the data strips in order to sustain real-time operation.

Generally speaking, applications for use with the system described above may be explicitly organized by a programmer as streams of data records processed by the kernel execution unit. A stream may be thought of as a finite sequence (often tens to thousands) of user-defined data records. An example of a data record for an image processing application is a single pixel from an image. Similarly, in a video encoder, each record may be a block of 256 pixels forming a macroblock of data. For wireless applications, each record may be a digital sample originally received from an antenna.

Referring again to FIG. 2, the stream load/store unit 270 executes memory load (load) or memory store (store) stream commands to transfer data between the external memory and the LRFs. In many cases, stream commands process between tens and thousands of data bytes of data at a time using memory access patterns provided with the commands. More specifically, memory access patterns may be used to specify the address sequence for the data transferred during loads and stores. These access patterns are defined by an external memory base address, an external memory address sequence, and an LRF address sequence. Base addresses are arbitrary byte addresses in external memory. The address sequence can be specified as a stride between subsequent records all at address offsets from the base address or as a sequence of indirect record offsets from a common base address.

Command arguments may describe the external memory access patterns by specifying record sizes and strides in external memory. The arguments, or call function parameters form a portion of a unique application programming interface (API). In one particular embodiment, the API provides the ability to fetch 2-dimensional records from external memory using straightforward call function parameters. Allowing programmers to access memory by referring to X, Y coordinate parameters is highly beneficial in that it reduces code complexity.

The call function parameters may be generally grouped into strided or indirect access patterns. A record generally comprises a user-defined collection of bytes that corresponds to either a 1D or 2D region of memory. For a single-dimension fetch, it's a contiguous group of bytes. For two-dimensional accesses, it's a sequence of rows of contiguous bytes with fixed address offsets that correspond to the linewidth.

During strided access patterns, call function parameters STRIDE_X, COUNT_X, and STRIDE_Y allow the programmer to control address incrementing between 2-D records on subsequent lanes. The algorithm involves incrementing an X offset by STRIDE_X from record N on lane (N % NUM_LANES) to record N+1 on lane (N+1% NUM_LANES) until N=COUNT_X, then incrementing Y offset by STRIDE_Y, until NUM_RECORDS 2D records are transferred in a stream.

Each 2D record contains a total of RECSIZE_X*RECSIZE_Y bytes in external memory. The RECSIZE_X call function parameter indicates the length in bytes from one line, forming the X-dimension of the record. The RECSIZE_Y call function parameter indicates the number of lines in the 2D record, forming the Y-dimension. The LINESIZE call function parameter indicates how large to stride in bytes between adjacent lines in the 2D record.

The physical memory addresses can be computed using the BASE and LINESIZE function call parameters, along with a value corresponding to the current x coordinate and y coordinate, where x and y coordinates can be thought of as relative offsets from the start of the 2D data structure in external memory. Addresses for each byte are calculated as BASE+y_coordinate*LINESIZE+x_coordinate.

During cropping, if the x coordinate is greater than the X crop value or the y coordinate is greater than the Y crop value, accesses to external memory for those bytes are suppressed during stores and are replaced with 0's in the stream data during loads. This essentially gives the programmer the ability to mask in memory space.

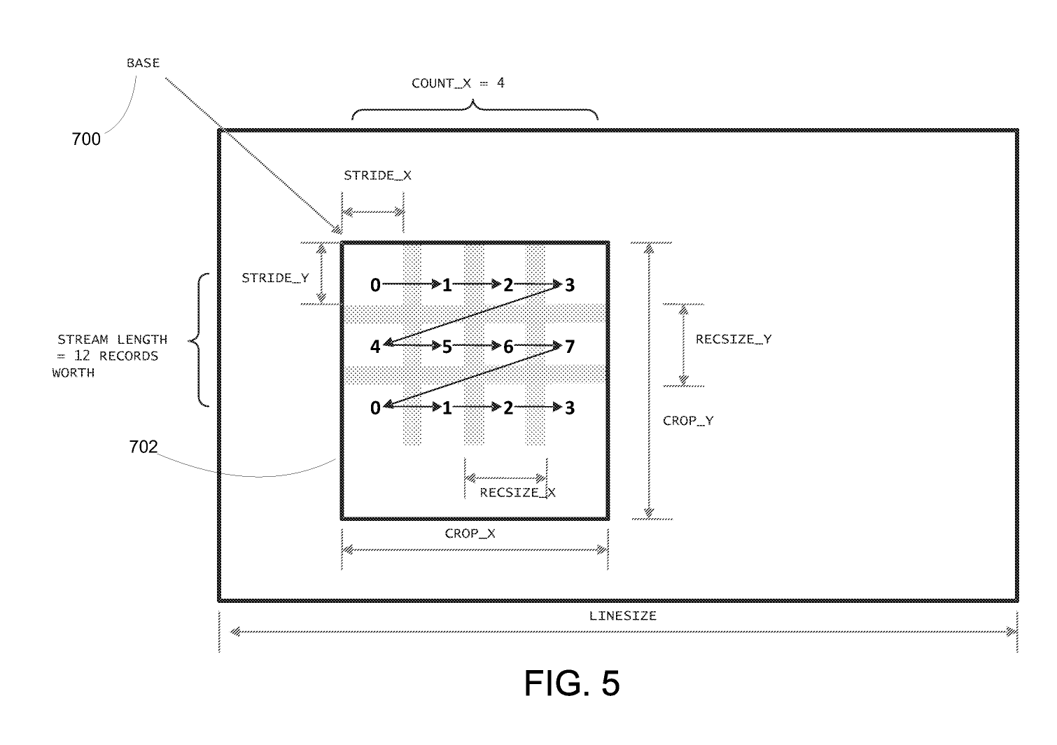

FIG. 5 illustrates an example of how a programmer may employ 2-D strided mode to access memory with COUNT_X=4, NUM_RECORDS=12, and NUM_LANES=8. The BASE descriptor sets the reference pointer for the rectangle, shown at 700. The CROP_X and CROP_Y function call parameters define the window bounded by rectangle 702. The twelve blocks within the window comprise twelve records worth of data, corresponding to the NUM_RECORDS call function parameter value of 12. Beginning with the upper left record, labeled “0”, and corresponding to the record for lane 0, additional records are accessed first in the X-dimension until the COUNT_X parameter of 4 is reached, then down a record in the Y-dimension to begin the next set of 4-record accesses at the far left. Record accesses proceed in a zig-zag pattern until all the records are fetched. Each lane receives one record in turn.

During indirect access patterns, a sequence of 2-D offsets are read from an indirect offset stream. Each offset provides respective start x and y pointers. After setting the starting x and y pointers, STRIDE_X and COUNT_X control the increment of addresses between 2D records on subsequent lanes. The algorithm involves incrementing X pointer by STRIDE_X from record N on lane (N % NUM_LANES) to record N+1 on lane (N+1% NUM_LANES) until N==COUNT_X, after which point the next offset is fetched from the indirect offset stream. Note that STRIDE_Y is ignored during 2-D indirect mode. (−1,−1) can be treated as a special “null” offset which does not store the record back to external memory during stores and loads 0s for the record during loads. A 2-D window specified by <CROP_X,CROP_Y> also controls squashing in the same manner as strided patterns.

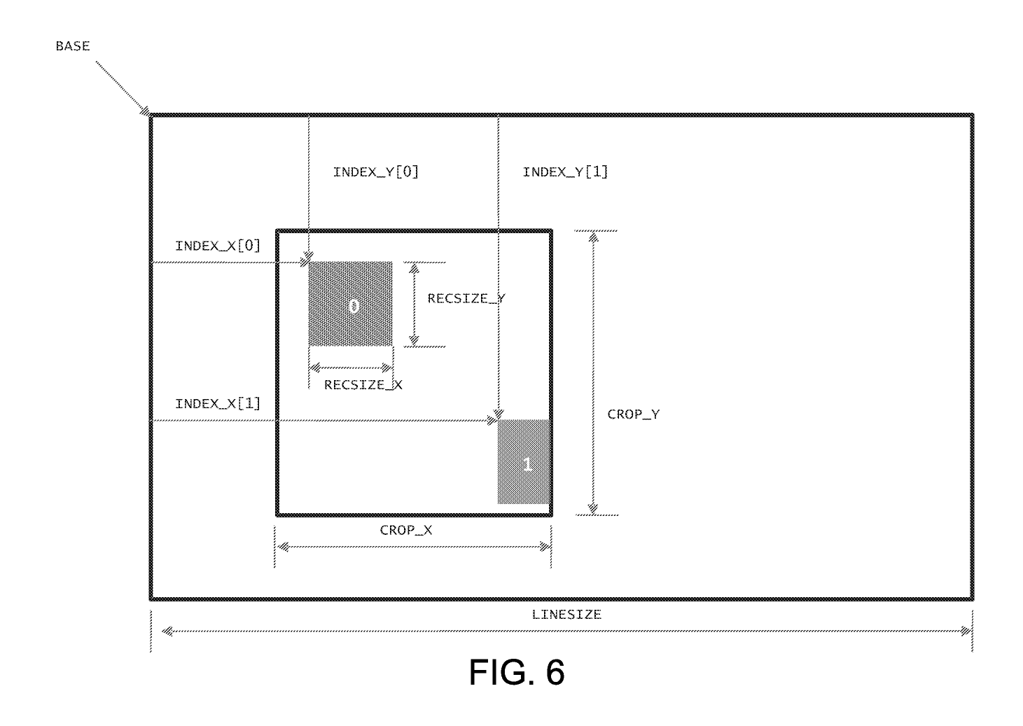

FIG. 6 shows an example of how 2-D indirect mode accesses memory with COUNT_X=1 and NUM_RECORDS=2. Since COUNT_X=1 in this example, STRIDE_X is ignored. With CROP_X and CROP_Y defining the window boundary for the record accesses, the base pointer for the first record for lane 0 is shown offset by respective y-index and x-index values INDEX_X[0] and INDEX_Y[0]. Additionally, the second record incurs an offset specified by a second set of index pointers INDEX_X[1] and INDEX_Y[1].

The call function parameters, or descriptors, are identified in the table below.

TABLE 1
Example of Call Function Parameters

| Descriptor | | Example in FIG. 8 |
|---|---|---|
| BASE | Base pointer to memory at a byte granularity | Top left corner of cropped window |
| RECSIZE_X | Length in bytes from one line that forms the X- | Length of record in X-dimension |
| | dimension of the record for one lane (also the full record | |
| | length for 1-D records) | |
| STRIDE_X | Stride between subsequent records in bytes (implies | X-dimension record address |
| | accessing a record for a new lane | increment |
| LINESIZE | Line width in memory or stride between subsequent | Row length |
| | rows of bytes within a record | |
| RECSIZE_Y | Height of record (number of lines of RECSIZE_X to | Y-dimension height of record |
| | form one record) | |
| COUNT_X | Number of records to access using STRIDE_X until | Number of records in each row |
| | going to the next row | |
| STRIDE_Y | Once done with COUNT_X, apply | Y-dimension record address |
| | STRIDE_Y*LINESIZE address increment | increment |
| CROP_X | Maximum allowable X width in bytes before cropping | X-dimension for cropped window |
| CROP_Y | Maximum allowable Y height in lines before cropping | Y-dimension for cropped window |
| NUM_RECORDS | Total number of 2D records to transfer | Number of records within cropped |
| | | window |

Once data records are requested from external memory and arranged into a sequence of records belonging to the stream to be loaded, the data in the stream is processed for the lanes along the return path.

Further complicating the loading or storing of the data from/to external memory, modern DRAM memory systems have relatively long data burst requirements in order to achieve high bandwidth. DRAM bursts are multi-word reads or writes from external memory that can be as high as hundreds of bytes per access in a modern memory system. Memory addresses sent to the DRAM facilitate the data transactions for these bursts, not individual bytes or words within the burst.

The stream load/store unit 270 (FIG. 2) is capable of taking these external memory access patterns, record partitioning across the LRFs, and converting these into sequences of burst addresses and transferring individual words from those bursts to/from the LRFs 266.

DRAM bandwidth utilization is heavily affected by the ordering of burst addresses. In a 16-lane processor, the stream load/store unit accesses data from 16 2D records at a time. For small records, a common ordering is to access all of the bytes from the first record before moving to subsequent records. However, in a data-parallel processor, if one is accessing long records, very large FIFOs would be required with this burst ordering. In order to avoid this silicon cost, the stream load/store unit processes each record from the 16 lanes in small batches, typically similar in size to a DRAM burst, until all bytes from 16 records have been processed. During access patterns where this ordering could create bottlenecks in DRAM performance, the stream load/store unit optionally supports prefetch directives to the cache 282 in order to optimize the order of DRAM burst read requests and improve overall DRAM bandwidth utilization.

### Load/Store Operation—External Memory Request Path

In general, during execution of a specific stream command, a DPU dispatcher (not shown) sends the command to the address generator 301 (FIG. 4). The address generator parses the stream command to determine a burst address sequence based on the memory access pattern. This involves determining whether the pattern is strided, indirect, and to what extent are byte offsets involved. As individual address requests are sent to DRAM, the address generator also analyzes the current burst address request to determine if a particular lane has any data that belongs to its LRF partition corresponding to the current burst and encodes this information in a tag. In the case of loads, these tags are saved and used by the memory read response circuitry. In the case of stores, as individual address requests are sent to DRAM, the address generator also sends the tag information to each lane's store circuitry to indicate if that lane should issue data as part of the pending request. If a lane has data corresponding to that burst, it sends its data out with the current burst.

More specifically, and referring back to FIG. 4, as the address generator 301 receives stream commands in the form of store descriptions, the record pointer generator 502 figures out the base for each of the corresponding 2D records. Once the base pointers are determined for a given stream of records, individual pointers corresponding to each lane, called intra-record pointers (shown as 506a-506n) are updated. As an optimization, the record pointer generator issues a base for every line in the X-dimension of every record, rather than the base X,Y pointer for the record. For some applications, this may provide a computational benefit.

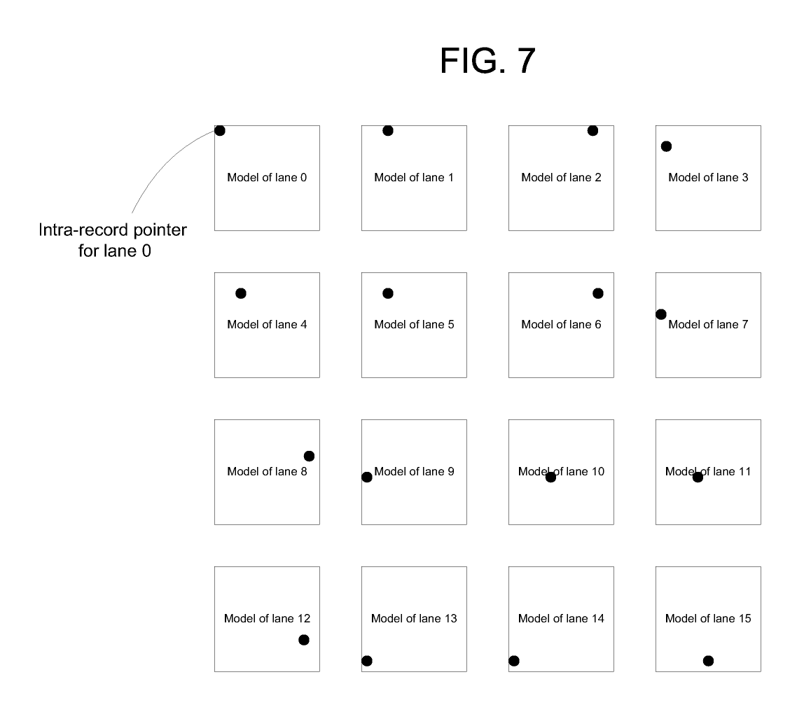

As an example of the intra-record pointer updating, and referring generally to FIG. 7, assume for example that the record size is 4. The request generator knows that the record size is 4 and sends a request for 4 bytes from each lane until all 16 lanes are done. The per-lane resources within the address generator then carry out a variety of tasks. Starting with lane 0, the request generator generates a burst request corresponding to that lane's intra-record pointer module. The request generator broadcasts this burst address to all intra-lane record pointer modules. These modules independently determine whether their next access falls within this burst. If so, this is a match, and the module provides the byte offset and count within this burst for the data requested by the corresponding lane. All intra-record pointers which matched are then updated accordingly. The request generator proceeds to sequentially query all lane intra-record pointer modules until all lanes are done. By coalescing the data belonging to multiple lanes into relatively complete memory requests at or near the DRAM native burst size, request traffic efficiency is significantly optimized.

The size of the coalesced memory requests depends on the application envisioned. Generally speaking, however, design considerations regarding the size of the on-chip memory LRFs 266 tend to limit memory burst sizes. In one particular embodiment, burst sizes are limited to 32 bytes per lane from an individual record. Depending on the application, one can always add more buffering to support a larger burst size, or add caching later on in the memory system to handle spatial locality concerns.

Referring briefly back to FIG. 2, the external memory interface 305 handles routing of address requests and data values between the address generator and LRFs with the optional cache 282 (FIG. 1) and external DRAM channels. In a system without a cache, if the address requests are restricted to native request sizes supported by each DRAM channel, the implementation is straightforward. For example, if each DRAM channel supports up to 32 byte bursts, the address requests sent out by the address generators could directly correspond to 32 byte bursts and memory requests could be supplied directly to the DRAM channel.

In a system with an optional cache 282, the address requests made by the address generators are not limited to native DRAM requests and redundant accesses can be supported. For example, consider a situation where each DRAM channel supports 32-byte bursts and the cache contains a 32-byte line size. If one indirect-mode access requests the lower 16 bytes from that burst for a data record, then that burst will be loaded into the cache. If an access later in the stream accesses the upper 16 bytes to the same burst, instead of accessing external memory to re-fetch the data, the data can be read out of the cache. A system with a cache 282 can also support address requests from the address generator to non-burst-aligned addresses. Individual address requests to bursts of data can be converted by the cache into multiple external DRAM requests.

During stores, in parallel with address computation, words may be transferred from the LRF 266 into the data fifo 406 (FIG. 3). Once enough words have been transferred into the data fifo to form the first address request, the address generator 301 (FIG. 4) issues an address request and a corresponding write tag. If any data elements from the current burst are in this lane's data fifo 406, write data will be driven onto the bus to correspond to this address request.

As a load request is issued, the request generator creates a tag that is sent along with the address requests to the external memory interface where it is buffered. When the read tags and data return, the record reconstruction FIFO 422 decodes the tag information to determine whether any of the data in the read response is to be accepted by the FIFO's particular lane, and packs that data into the lane FIFO accordingly.

To avoid the need for large FIFOs in the lane load interfaces 351, the request path is decoupled from the return path. Generally speaking, the system sends all the tags out to the external memory system and is completely agnostic to whether there's space available for those requests to land back into the load interface FIFO's. When the return data comes back, because it's routed on a flow control path decoupled from the request path, the load interface FIFOs do not overflow. This provides a significant memory latency tolerance advantage since the address generator 301 does not need to wait for read data to return or space to free up in the load interface return FIFOs before sending new requests to external memory.

### Load/Store Operation—External Memory Return Path

When bringing data back on-chip from the external memory, managing and processing the data from the DRAM domain to the lane register file domain is important. To accomplish this domain crossing, the shared response FIFO interacts with the various record reconstruction FIFO's employed for each lane. As read data returns back from the external memory, sequences of bursts comprising multiple records for distribution across multiple lanes are broadcast by the shared response FIFO to each of the lanes in the same order as they were requested by the address generator. As bursts are directed to each load interface, each load FIFO employs its record reconstruction FIFO 422 to handle arbitrary byte offsets. This provides an intermediate buffer to grab the arbitrarily aligned chunks of DRAM bursts, and glue them back together into an aligned burst that may then be used by the LRFs 266. (Note, this is essentially the inverse of what the address generator does: takes records from the LRFs, and splits them up into bursts for transmission into the DRAM domain).

The record reconstruction FIFO 422 plays an important role in the “decoupled” interconnect scheme. Load requests sent out to the external memory have no knowledge of what's going on in the response path. Once responses come back, the record reconstructor provides an independent circuit that deals with taking those responses, making sure the data in the responses go to the right places. Information in the tags allows the record reconstructor to coalesce bursts into records for use in a specified lane. Point-to-point flow control all along the return path ensures that the DRAM memory controller 246 (FIG. 1) does not overflow. In an exemplary embodiment, the optional cache implementation assists the interconnect in routing and buffering tags.

Another advantage to the decoupled architecture is that there may be all sorts of actions occurring in the LRF 266—a kernel could be overusing bandwidth, and causing contention back to the stream loads, and so forth. To address this problem, the tags keep track of the transactions. The address generator sends everything that's needed to know about where the data needs to go back into the lanes. A key assumption here is that once the responses go back into the lanes, everything is assumed to be in order. In other embodiments, out of order responses are allowed.

During loads, once read requests return from either the cache or external DRAM, a read tag corresponding to the request is fed to the record reconstruction FIFO for decoding. If any of the elements from the current burst correspond to words that belong in this lane's LRF 266, then those data elements are written into the data fifo 416. Once the data fifo's accumulate enough data elements across all of the lanes, then words can be transferred into the LRFs.

Many of the key features described herein, such as the application programming interface, the decoupling between the request and return paths, and the address generator lend themselves to many different applications, beyond the stream processing or data parallel processing space. For example, multi-core architectures both with caches and local memories may benefit from the teachings described herein. The features described are equally applicable for embodiments involving graphics processing units and the like.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the present invention. In some instances, the terminology and symbols may imply specific details that are not required to practice the invention. For example, any of the specific numbers of bits, signal path widths, signaling or operating frequencies, component circuits or devices and the like may be different from those described above in alternative embodiments. Also, the interconnection between circuit elements or circuit blocks shown or described as multi-conductor signal links may alternatively be single-conductor signal links, and single conductor signal links may alternatively be multi-conductor signal links. Signals and signaling paths shown or described as being single-ended may also be differential, and vice-versa. Similarly, signals described or depicted as having active-high or active-low logic levels may have opposite logic levels in alternative embodiments. Component circuitry within integrated circuit devices may be implemented using metal oxide semiconductor (MOS) technology, bipolar technology or any other technology in which logical and analog circuits may be implemented. With respect to terminology, a signal is said to be “asserted” when the signal is driven to a low or high logic state (or charged to a high logic state or discharged to a low logic state) to indicate a particular condition. Conversely, a signal is said to be “deasserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or deasserts, if explicitly stated or indicated by context) the signal on a signal line coupled between the signal driving and signal receiving circuits. A signal line is said to be “activated” when a signal is asserted on the signal line, and “deactivated” when the signal is deasserted. Additionally, the prefix symbol “/” attached to signal names indicates that the signal is an active low signal (i.e., the asserted state is a logic low state). A line over a signal name (e.g., ‘ <̅s̅i̅g̅n̅a̅l̅ n̅a̅m̅e̅>̅’) is also used to indicate an active low signal. The term “coupled” is used herein to express a direct connection as well as a connection through one or more intervening circuits or structures. Integrated circuit device “programming” may include, for example and without limitation, loading a control value into a register or other storage circuit within the device in response to a host instruction and thus controlling an operational aspect of the device, establishing a device configuration or controlling an operational aspect of the device through a one-time programming operation (e.g., blowing fuses within a configuration circuit during device production), and/or connecting one or more selected pins or other contact structures of the device to reference voltage lines (also referred to as strapping) to establish a particular device configuration or operation aspect of the device. The term “exemplary” is used to express an example, not a preference or requirement.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

We claim:

1. An application programming interface for loading and storing multidimensional arrays of data between a parallel processing unit and an external memory, the external memory referenced using a sequence of physical addresses defining two-dimensional arrays of data storage locations corresponding to records, the parallel processing unit having multiple processing resources to parallel process records residing in respective register files, the interface comprising:
an X-dimension function call parameter to define an X-dimension in the memory array corresponding to a record for one lane;
a Y-dimension function call parameter to define a Y-dimension in the memory array corresponding to the record for one lane; and
wherein the X-dimension and Y-dimension function call parameters cooperate to generate memory accesses corresponding to the records.

2. The application programming interface of claim 1 wherein the external memory accesses comprise a sequence of record accesses at fixed intervals.

3. The application programming interface of claim 1 wherein the external memory accesses comprise a sequence of record accesses at multiple arbitrary offsets.

4. The application programming interface of claim 3 wherein at least one of the offsets points to a sub-sequence of accesses at fixed intervals.

5. The application programming interface of claim 1 and further comprising:
a base pointer function call parameter to establish a reference position for defining the records in the external memory.

6. The application programming interface of claim 1 and further comprising:
a stride X function call parameter to define the stride length between subsequent records in the X dimension.

7. The application programming interface of claim 1 and further comprising:
a line width function call parameter to define the line width in external memory between subsequent rows of bytes within a record.

8. The application programming interface of claim 1 and further comprising:
a crop X function call parameter to prevent external memory accesses outside a two-dimensional region in the X dimension.

9. The application programming interface of claim 1 and further comprising:
a crop Y function call parameter to prevent external memory accesses outside a two-dimensional region in the Y dimension.

10. The application programming interface of claim 1 and further comprising:
a record X count function call parameter to define a group of records to access in the X dimension.

11. The application programming interface of claim 1 and further comprising:
a stride Y function call parameter to define the stride length between subsequent groups of records in the Y dimension.

12. The application programming interface of claim 1 and further comprising:
a record counts function call parameter to define the total number of records to be accessed.

13. The application programming interface of claim 1 wherein the parallel processing unit comprises a data parallel processor.

14. A hardware address generator to map data between parallel processing resources in a parallel processor and external memory, the external memory having a native memory access protocol, the address generator comprising:
at least one record pointer generator to receive load/store instructions comprising multidimensional memory access patterns defined by an application programming interface; and
a request generator to generate a sequence of memory access requests with the native memory access protocol based on the multidimensional memory access patterns.

15. The hardware address generator of claim 14 wherein the native memory access protocol comprises a native memory access burst width.

16. The hardware address generator of claim 15 wherein the native memory access burst width comprises a dynamic random access memory burst width.

17. The hardware address generator of claim 14 wherein the memory patterns comprise strided access patterns.

18. The hardware address generator of claim 14 wherein the memory patterns comprise indirect access patterns.

19. The hardware address generator of claim 14 wherein request generator optimizes the order of the memory access requests to the external memory to minimize temporary buffering.

20. The hardware address generator of claim 14 wherein the parallel processor comprises a data parallel processor.

21. The hardware address generator of claim 14 wherein the request generator issues memory access requests comprising a physical memory address and a tag representing how the associated data is to be loaded into the data parallel processor.

22. The hardware address generator of claim 21 wherein each tag specifies match, offset and record size information associated with each lane.

23. An on-chip memory system interconnect to load data to processing resources in a parallel processor from external memory, the interconnect comprising:
a request path including an address generator having an input to receive pattern descriptors from an application programming interface, the address generator to generate external memory burst requests for transmission to the external memory, the burst requests including physical memory addresses and routing tags; and
a return path decoupled from the request path, the return path including a shared response FIFO to receive data bursts from the external memory corresponding to the burst requests and the routing tags, the shared response FIFO coupled to a plurality of per-resource FIFOs disposed in the parallel processing lanes, the shared response FIFO operative to distribute the data bursts to the respective per-resource FIFOs depending on information in the tags.

24. The on-chip memory system interconnect according to claim 23 wherein each per-resource FIFO includes a record reconstruction FIFO to reassemble record fragments from the shared response FIFO into a format native to the per-resource FIFO.

25. The on-chip memory system interconnect of claim 23 wherein the routing tags identify local register file locations for loading portions of the data bursts.

26. The on-chip memory system interconnect of claim 23 wherein the plurality of per-resource FIFOs determine whether to write data from particular data bursts into respective local register files based, at least in part, on the routing tag information.

27. The on-chip memory system interconnect of claim 23 wherein the parallel processor comprises a data parallel processor, and the per-resource FIFO's comprise lane response FIFO's.
